(19) United States
(12) Patent Application Publication
(10) Pub. No.: US 2010/0300374 A1
(43) Pub. Date: Dec. 2, 2010

(54) FLUME SYSTEM

(75) Inventor: Robert John Thompson, Queensland (AU)

Correspondence Address: STOUT, UXA, BUYAN & MULLINS LLP, 4 VENTURE, SUITE 300, IRVINE, CA, 92618, US

(73) Assignee: WATERJET CORPORATION PTY LTD, Arundel, Queensland, AU (AU)

(21) Appl. No.: 12/602,497

(22) PCT Filed: May 30, 2008
(86) PCT No.: PCT/AU08/00771

§ 371 Date: Jun. 1, 2010

Related U.S. Application Data
(63) Continuation-in-part of application No. PCT/AU2008/000771, filed on May 30, 2008.

(30) Foreign Application Priority Data
May 31, 2007 (AU) 2007902921
Oct. 30, 2007 (AU) 2007905936

(51) Int. Cl. A01K 15/02

(52) U.S. Cl. 119/704

(57) ABSTRACT

A flume system is adapted for use as an animal exercise pool.

### CROSS-REFERENCE TO RELATED APPLICATIONS

This application is a continuation-in-part of International Application No. PCT/AU2008/000771, filed on May 30, 2008, which claims the priority benefit of Australian Patent Application No. 2007902921, filed on May 31, 2007, and Australian Patent Application No. 2007905936, filed on Oct. 30, 2007, the entire contents all of which are hereby incorporated by reference.

### FIELD OF THE INVENTION

The present invention relates to flume systems and particularly to flume systems adapted for use as animal exercise systems.

### BACKGROUND OF THE INVENTION

An excellent discourse on the use of flume systems as animal exercise devices is presented in Australian Patent Application No. 2005100128, and an extract of the Background of the Invention portion of that document follows verbatim:

“As with humans, animals also need to be exercised, especially racing animals, such as thoroughbred racehorses. The training of racehorses, for example, involves track work and walking of the horses. Due however, to the popularity of horse racing there is an ever-increasing demand on the availability of race tracks as a training venue. In order to maximise the use of [race tracks] and the limited time available for track work, the horse or horses need to be well exercised . . . before actually running on the track. Typically the exercising of horses is achieved by simply walking the horses. There have been a number of ways in which horses can be exercised by walking. The simplest way is by tethering a horse to one end of a rope, the other end of which is held by the trainer who encourages the horse to walk in circles. Another of the most common ways of walking horses involves a circular track with profiled rail runs and rotatable radial screens mounted in the runs between which screens the horses are positioned and driven around the track.

In recent times trainers have been attempting to train and exercise horses in water. One of the benefits arising from exercising horses in water is that the horses have to work against the resistance of the water to motion. As the public use of beaches and rivers increases, this is no longer practical or possible in many cases. The need for an economical and cost efficient method is all too evident. The exercising of horses in water up to shoulder depth, working against the resistance of the water, ensures greater levels of fitness, whilst protecting the horses legs from excessive weight and stress levels.

One of the current methods involves a narrow channel, usually circular, filled with water through which horses are encouraged to either walk or swim. Such a prior art apparatus do not seem however to adequately exercise the horses correctly. This type of method and apparatus has the following disadvantages:
narrow channels;
inadequate water resistance for proper exercising of muscles because of the design of the existing water-walkers, the water begins to flow in a ‘whirlpool’ effect, which actually carries the horses forward, thus greatly reducing the ‘resistance’ effect needed to exercise horses properly; and
excess water splashing when changing direction of horses in water-walkers. When changing direction in the existing water-walkers, the horses are faced with a huge wall of water, caused from the ‘whirlpool’ effect of travelling in the previous opposite direction. This causes horses to start jumping' and not walking through the water, and which is unsafe especially for horses in rehabilitation or recovering from injury.”

The apparatus taught in Australian Patent Application No. 2005100128 includes a liquid holding means adapted to hold a body of liquid, typically water, a circular raceway, the raceway including an inner fence and an outer fence adapted to define a circular pathway through which animals are directed, a rotatable vertical shaft supported on a support assembly position in the centre of the liquid holding means, drive means adapted to rotate the vertical shaft, and at least one radial arm attached to the vertical shaft, wherein each radial arm is adapted to extend outwardly from the vertical shaft, a grid panel attached to each radial one, wherein each grid panel is adapted to extend into each pathway and to come into contact with an animal as the radial arm and associated grid panel is rotated so as to motivate the animal to move within the pathway and entry/exit means adapted to allow the animals to enter and exit the pathway.

This device, whilst useful, also has continued disadvantages such as waste buildup in the pool and the apparatus does not address the “whirlpool” effect in the pool. Indeed, providing grip panels which are rotatably driven actually compounds the “whirlpool” issue.

Other prior-art devices exist. For example, one form of exercise facility is illustrated in U.S. Pat. No. 3,691,995. This patent shows a large swimming pool with no facility for resisting the movement of the horse or other animal using the pool and there are no facilities for cleaning the pool or the water contained therein.

In another form of prior-art device, a treadmill was provided in a body of water in U.S. Pat. No. 3,485,213. In general, the animal, and specifically a horse, had essentially his entire weight rested upon his legs while running on a treadmill 36, the animal's legs being submerged in water, but supporting essentially the entire weight of the animal. Such devices are expensive, difficult to maintain and operate, and present a hazard to the lower legs and hoofs of animals using the apparatus.

There is illustrated in U.S. Pat. Nos. 3,543,724 and 3,543,725 an exercise system wherein the animal is permitted to swim while being held in place. The restraint on the animal restricts the full use of its muscles and requires very close supervision and control to be sure that the animal does not drown and is not injured.

Finally, there is shown in U.S. Pat. No. 3,835,815 an animal conditioner wherein the animal is maintained in a sling in a body of water for swimming action. The presence of the sling makes it unnecessary for the animal to swim if it does not desire to do so, and, again, careful continual supervision must be maintained at all times to be sure that the horse does not drown and is not injured.

Therefore, there continues to be a need for a cost-effective solution to providing a flume system for exercising animals that addresses the “whirlpool” problem, and which may also decrease waste build-up in the pool from the animals exercising.

It will be clearly understood that, if a prior-art publication is referred to herein, this reference does not constitute an admission that the publication forms part of the common general knowledge in the art in Australia or in any other country.

### SUMMARY OF THE INVENTION

The present invention is directed to a flume system, which may at least partially overcome one or more of the abovementioned disadvantages or provide the consumer with a useful or commercial choice.

In a form, the invention resides in a flume system including
1. an annular raceway with at least one inner and at least one outer wall and adapted to hold a body of liquid,
2. an entry and exit associated with the annular raceway, and
3. a plurality of baffles associated with one or more of either the inner or outer walls, each baffle configured as a depression having at least one angled surface extending away from the inner surface of the wall in which the baffle is located.

In a further form, the invention resides in a flume system including
1. an annular raceway with at least one inner and at least one outer wall and adapted to hold a body of liquid,
2. an entry and exit or entry/exit means associated with the annular raceway, and
3. a waste removal system associated with the annular raceway including at least an annular overflow drain provided on either the inner or outer wall to remove floating waste, the overflow drain defined between a wall extending into the annular raceway and the inner or outer wall of the raceway.

Typically, this element of the waste removal system will be referred to as a spillway.

In another form, the invention resides in a flume system including
1. an annular raceway with at least one inner and at least one outer wall and adapted to hold a body of liquid,
2. an entry and exit or entry/exit means associated with the annular raceway, and
3. a waste removal system associated with the annular raceway including at least one opening in a lower portion of one or more of either the inner or outer wall of the raceway associated with a suction and filtration means or assembly to remove submerged waste.

Any one or more of the inventive features, namely:
the depression baffles;
the waste removal system with the spillway; or
the waste removal system with the submerged waste removal system may be used in combination with each other and according to the most preferred embodiment, all of the elements will be used to provide a flume system of superior functionality.

In an embodiment, the entry/exit intersects the raceway at an acute angle. In an alternative embodiment, the entry/exit extends perpendicularly from one side of the raceway.

Normally, the flume system will be configured as a liquid holder or holding means adapted to hold a body of liquid, typically a tank or similar with the annular raceway, located within a larger liquid holding means. Additionally, the two main elements of the system, namely the entry and exit and the annular raceway will typically be referred to as the entry/exit raceway and the exercise raceway.

The flume system of the invention is designed to provide a complete solution to the problems of the “whirlpool effect,” animal safety, ease and safety of ingress and egress of the animal from the pool, and waste removal to maintain the water as clean as possible.

The flume system of the present invention is typically for use as an animal exercise pool. The pool of the preferred embodiment will normally be used to exercise horses but the system may easily be adapted to allow for the exercise of other types of animals. Normally, the exercise pool will be used for rehabilitation or conditioning of animals.

Exercise within the pool of the preferred embodiment will normally occur for periods of approximately 20 minutes, whereas in prior-art pools exercise periods of up to 50 minutes were usually required due to the decreased resistance provided by the whirlpool effect. Studies have found that exercising or conditioning an animal for periods of over 30 minutes can negatively affect the animal.

The system of the present invention is preferably adapted for use in both directions. For example, exercising an animal in the pool such as the present invention normally involves the animal moving in the first direction for a period of time and then turning the animal and travelling in the reverse of the first direction for an equal period of time.

Animals exercising in the system of the present invention may swim but will preferably walk about the exercise raceway and the depth of the pool (and the depth of liquid in the pool) is preferably appropriate for this purpose. Of course the level of liquid in the pool will be such as to allow for the increase in depth or displacement which will occur with a number of animals at least partially submerged within the liquid.

According to a particularly preferred embodiment, the flume system of the present invention normally includes a tank which will typically be located at least partially below ground level.

The system of the invention includes an annular raceway with at least one inner and at least one outer wall and adapted to hold a body of liquid. According to the most preferred embodiment, the annular raceway will typically be circular but may be provided in other shapes, for example oval. The raceway is preferably not rectangular or possessing sharp corners as these not only make it more difficult for the animal to move about the raceway, but also increase points where waste, for example, may accumulate. The annular raceway is typically an annular channel defined between the inner and outer walls.

The inner and outer walls of the raceway may be arcuate and appropriately curved to form concentric circular walls. Each of the inner and outer walls may be formed of a plurality of arcuate wall sections adapted to be attached to one another to form the walls. The walls may be generally square or rectangular. In an embodiment, the outer wall is rectangular with rounded corners, and the inner wall is arcuate. The raceway may be a different shape to the inner and/or outer walls. For example, the outer wall may be generally rectangular or rectangular, and the raceway within may be circular. This creates corner areas in the tank in which the water and particularly the animal waste can collect due to the overflow of the water from the raceway due to the whirlpool effect in an upper region of the tank.

Further, the raceway, and the tank in general, will normally have a substantially planar floor.

Where the outer and/or inner walls are a different shape to the raceway, preferably a railing is provided to form an outer side(s) of the raceway. Preferably the baffles extend from the railing or a mid-wall between the railing and the outer wall. Preferably the mid-wall is a low height raceway wall that is shaped similarly to the railing and perimeter of the raceway. In an embodiment where the raceway is circular and the outer wall is rectangular, a railing within the rectangular wall is preferably circular shaped, and a circular shaped low height raceway wall with the baffles extending therefrom preferably surrounds the railing and tangentially meets the sides of the outer wall. In the space between the low height raceway wall and the corners of the outer wall there is preferably a drain sump. Preferably the sump is lined with fibreglass and has a drain/outlet connected therewith.

The inner wall is typically a wall with a particular cross sectional shape. In particular, the inner wall is preferably provided with a substantially vertical lower portion which extends approximately perpendicularly to the floor, an angled portion extending upwardly and into the annular channel towards the outer wall, and a substantially vertical upper portion which is located closer to the outer wall than the lower portion.

By providing a wall with this cross sectional shape (or similar), the legs of animals which are located within the annular channel are maintained at a distance from the lower portion of the sidewall of the pool. Normally, the upper portion of the inner wall begins at a height above the floor appropriate to locate the upper portion adjacent (but spaced and appropriate distance from) the animal's body or torso (rather than the animal's legs) once the animal is located in the annular channel.

According to a particularly preferred embodiment, the lower wall is between approximately 1 to 1.5 m in height, the upper wall is between approximately 50 cm to 1 m in height, and the angled portion is typically between 50 cm to 1 m in height.

The outer wall is typically a substantially planar sidewall although the outer wall may have shaped portions provided. The outer wall is substantially vertical and normally extends substantially perpendicularly to the floor of the pool. Typically, the outer wall will be continuous except for a portion removed or absent to allow the entry and exit to communicate with the annular raceway.

There will typically be a closure or closure means provided to control or prevent entry of the animals from the entry and exit into the annular raceway. The closure will normally be a gate or similar device. When closed, the closure will typically form a part of the outer wall so that animals circling in the annular raceway cannot exit the raceway unless the closure is open. Normally, the closure is provided only at an upper portion of the outer wall with the remainder of the entry being clear and will preferably be similar in height to the upper portion of the outer wall.

The system of the present invention is also provided with an entry and exit or entry/exit means associated with the annular raceway. Normally, the entry and exit will be a ramp which extends downwardly to the raceway with the floor of the entry and exit being angled and smoothly intersecting with the floor of the annular raceway.

The entry and exit will typically be provided with a pair of substantially parallel sidewalls that each meet with a portion of the outer wall of the raceway on opposite sides of an entry opening. The floor of the entry and exit ramp is typically provided with grip or grip means in order to minimise slippage of animals upon entry and exit from the pool.

Generally, the entry and exit ramp intersects the annular raceway at an acute angle. This preferably allows entry of the animal through the entry raceway in the direction of travel in the initial direction and allows the animal to more easily enter the exercise raceway. Once the animal has been turned into the opposite direction to that first traveled upon entry into the annular raceway, the animal can exit the exercise raceway simply and easily as the animal is typically facing the entry and exit ramp and is not required to execute a turn in order to access the entry and exit ramp. The entry and exit ramp is normally provided approximately tangentially to the circular or oval exercise raceway.

Cushioning or cushioning means may be provided at the corners of the entry and exit ramp and the outer wall in order to further minimise the chances of injury to the animals.

The present invention may also be further provided with a plurality of baffles associated with one or more of the inner or outer walls, each baffle configured as a depression having one or more angled surface extending away from the inner surface of the wall in which the baffle is located. These baffles will normally be referred to as “depression baffles.”

Normally, the baffles are provided in the form of substantially V-shaped or Y-shaped depressions with a pair of angled surfaces meeting each other at an apex. Preferably, the apex of the depression is located away from the inner surface of the wall in which the baffles are provided. It is preferred that the baffles will be formed of a rubberised material in order to have sufficient strength but also to be resilient to resist damage or injury to the animals using the pool.

The baffles are normally provided in the outer wall, but it is anticipated that baffles may be provided in the inner wall, or in both walls. Alternatively, the baffles may be provided in a raceway wall between the inner and outer walls. The baffles preferably comprise a support member from which they are affixed to. The support member, which is preferably made of fibreglass, is preferably angled and affixed along a longitudinal edge to rubber panels which extend therefrom. The depression baffles will normally be provided in a lower portion of the wall. Normally, the depression baffles extend from the floor of the annular raceway upwardly towards the angled portion of a sidewall but not into the angled portion, with a constant cross sectional shape over their height.

Although not wishing to be limited by theory, the inventor of the present invention is found surprisingly that the angled walls of the depression baffles located within the annular raceway operate to reduce the whirlpool effect in each (both) direction(s) of travel, provided that the walls are angled relative to the direction which the animals are travelling within the annular raceway. The angled surfaces are therefore typically oriented at the same angle relative to the surface of the outer wall, but face in opposite directions.

The plurality of depression baffles will typically be spaced approximately equally about the outer wall. The number of depression baffles provided in a given flume system will typically be determined according to the size of the system, namely the circumferential dimension of the outer wall.

The depth of the depressions in the outer wall may also vary. The depth of the depressions may be changed by adjusting the angle of the angled surfaces to the outer wall. The angle at which the angled surfaces extend from the surface of the outer wall may vary depending upon the number of depression baffles provided, for example, steeper angles may be provided where fewer depression baffles are present.

Alternatively, one or both walls may be provided with a sawtooth pattern wall with a plurality of angled portions to disrupt the liquid flow and the whirlpool effect.

The flume system of the present invention also preferably further includes a waste removal system associated with at least the annular raceway. The waste removal system of the preferred embodiment usually includes a pair of elements, namely a waste removal spillway for the floating waste and a submerged waste removal portion for submerged waste, which may be used either separately or together for increased effectiveness.

The waste removal spillway will normally be located in an upper part of the exercise raceway. Typically, the spillway is located on the outer wall and extends inwardly toward the inner wall, that is, into the annular channel of the exercise raceway.

The shape of the waste removal spillway is preferably configured to mirror the shape of the inner wall, that is, the spillway will preferably include an angled wall extending upwardly and from the outer wall toward the inner wall, and a substantially vertical upper portion. Normally, the angled wall and the upper portion will define a channel with the outer wall.

Typically, the waste removal spillway is provided with at least one, and normally a plurality of, removable cover or cover means located in an upper portion of the spillway. The cover is preferably adapted to allow waste to escape through the cover but to prevent animals from placing body parts into the spillway.

Preferably, the cover has a plurality of slot openings configured in a grill formation. The cover will normally be manufactured in sections, typically of approximately 25 mm in length which may then be combined to form a flexible cover in order to allow easy placement and removal in the spillway. The cover or the spillway may be further provided with securing structure to prevent accidental dislodgement of the cover.

Generally, the upper portion of the spillway and the upper portion of the inner wall define an upper zone in the annular raceway, and a lower zone is typically defined between the outer wall and the lower portion of the inner wall. Preferably, the upper zone is narrower than the lower zone providing increased space in the lower zone of the exercise raceway for the animals' legs.

As alluded to above, the spillway is adapted to collect floating waste which will typically overflow into the spillway due to the turbulence created in the liquid generated by the animals movement within the exercise raceway. The waste will then typically be collected and undergo separation processes in order to remove the waste from the water prior to reintroduction into the pool through the filtration system. Typically, the separation processes will involve one or more filtration steps. There will normally be at least one removal outlet located through the outer wall and in communication with the spillway to remove waste and water from the spillway, and preferably one outlet will be provided per panel, each panel being approximately 2.4 m in length.

The waste removal system also typically includes a submerged waste removal portion which will typically be located in through lower zone of the exercise raceway. Normally, the submerged waste removal portion will include a number of openings located through the inner wall. Alternatively, the inner wall may simply include an upper portion including an angled wall and substantially vertical upper portion supported on a plurality of elongate leg members. Typically, the small amount of agitation in the liquid created by the animal's movement will tend to concentrate any submerged waste in the centre of the pool. Provision of openings in the inner wall allows collection and removal of submerged waste through the centre of the pool.

Typically, any openings provided may be associated with suction, suction means, directional liquid returns and/or directional liquid returns to assist with the collection of the submerged waste. The openings themselves may be covered by removable covers or cover means such as grates or grills, in order to prevent animals from accidentally inserting body parts into the openings and becoming stuck or injuring themselves. Preferably however, the surface area of the inner wall is decreased as much as possible as this both increases the ability of the waste to move to the centre of the pool for collection and reduces drag on the walls.

In addition to the openings in the inner wall, one or more depressions may be provided in the floor of either the exercise raceway or the pool itself. One or more radial depressions may be provided inside the inner wall. The depressions may assist with the collection of submerged waste and normally there will be one or more outlets located in communication with the depressions.

One or more directional liquid returns or return means will typically be provided toward the centre of the pool, inside the inner wall to assist with the collection and removal of submerged waste through the radial depressions at the centre of the pool. The returns are typically provided through the floor and extend upwardly. The returns may be radial and oriented to force liquid returning to the pool to the centre of the pool. One or more directional caps or means may be used.

Normally, the inner and outer walls will be modular and typically manufactured of a plastic material although other materials such as moulded fibreglass, or composite material may be used. The inner and outer walls are preferably integrally formed with all sidewalls and spillway walls. Typically, all of the surfaces provided will be smooth with any hard angles minimised and rounded edges on all corners used to minimise the chances that an animal could injure themselves whilst using the pool.

According to alternative embodiments, an oval pool or an elongate pool may be provided. When provided in an oval configuration, the pool will normally have a ramp leading downwardly to an oval pool track and a second ramp leading away from the pool track. Normally, the ramps are configured to be tangential to the oval track.

When provided in the elongate configuration, there will preferably be a ramp located at either end of an elongate track.

According to a further alternative embodiment, a rotating animal separator or separation means may be provided so that more than one animal can exercise in the raceway at any one time without impeding any other animal. Preferably, the separator will include at least one barrier, gate or gate means oriented across the raceway and mounted to be spaced about the raceway. Normally, a plurality of barriers is provided with the space between respective barriers fixed, and the entire barrier assembly rotating around the raceway.

According to a particularly preferred embodiment, a plurality of supports or support means are preferably provided about the raceway but on the opposite side of the inner wall to the raceway itself. The supports preferably extend upwardly above the level of the walls. Each of the supports will preferably include guide means.

Preferably, a barrier support ring is provided, the ring being supported by the plurality of support means. Each of the supports provided will preferably be provided with a ring support member, typically one adapted to support rotation of the ring relative to the raceway. Normally, the ring support member will be a substantially circular and bearing member adapted for rotation about a substantially horizontal axis. The ring support member is typically mounted on an outer surface of each support and spaced from the upper end of the support such that the ring can be mounted relative to the support and its position fixed but allowing rotation.

The ring will preferably be provided with structure for imparting rotational force, normally a driver or drive means. The drive means may act on the ring itself or on a mechanism which rotates the ring.

According to other embodiments, the spaced opponent barriers may be provided on a ring which is rotated through a centrally located axle.

### BRIEF DESCRIPTION OF THE DRAWINGS

Various embodiments of the invention will be described with reference to the following drawings, in which:

FIG. 1 is a perspective view of a flume system embodied as a horse exercise pool without water according to a preferred embodiment of the present invention.

FIG. 2 is a view from above of a flume system embodied as a horse exercise pool according to a preferred embodiment of the present invention.

FIG. 3 is a sectional side view of the flume system illustrated in FIG. 2.

FIG. 4 is a further perspective view of a flume system embodied as a horse exercise pool without water according to a preferred embodiment of the present invention, with outer wall cladding and spillway covers removed.

FIG. 5 is a detailed view of the entry/exit of a flume system embodied as a horse exercise pool with water according to a preferred embodiment of the present invention.

FIG. 6 is a detailed view of the entry area at the end of the entry/exit of a flume system illustrated in FIG. 5.

FIG. 7 is a detailed view of the entry/exit illustrated in FIG. 5 without water.

FIG. 8 is a perspective view of a flume system embodied as a circular horse exercise pool without water and with separation gates according to a preferred embodiment of the present invention.

FIG. 9 is a side elevation view of a flume system embodied as an elongate horse exercise pool without water according to a preferred embodiment of the present invention.

FIG. 10 is a sectional end view of the flume system illustrated in FIG. 9 with baffle.

FIG. 11 is a sectional end view of an entry and exit ramp used with the flume system illustrated in FIG. 9 according to a preferred embodiment.

FIG. 12 is a perspective view of a flume system embodied as an oval horse exercise pool without water according to a preferred embodiment of the present invention.

FIG. 13 is a plan view of a flume system embodied as a horse exercise pool according to a preferred embodiment of the invention.

FIG. 14 is a side elevation cross-sectional view of the flume system illustrated in FIG. 13.

FIG. 15 is a side elevation cross-sectional view of an inner wall of the flume system illustrated in FIG. 13.

FIG. 16 is a side elevation cross-sectional view of a return pipe of the flume system illustrated in FIG. 13.

FIG. 17 is a side elevation cross-sectional view of a support for railing of the flume system illustrated in FIG. 13.

FIG. 18 is a plan view of the support (only) of FIG. 17.

FIG. 19 is a perspective view of a baffle of the flume system illustrated in FIG. 13.

FIG. 20 is a plan cross-sectional view of the baffle of FIG. 19.

FIG. 21 is a side elevation cross-sectional view of an outer wall and outer rail section of the flume system illustrated in FIG. 13.

FIG. 22 is a side elevation cross-sectional view of a drain sump of the flume system illustrated in FIG. 13.

FIG. 23 is a side elevation cross-sectional view of a rotating mechanism of the flume system illustrated in FIG. 13.

FIG. 24 is a dividing panel of the flume system illustrated in FIG. 13.

FIG. 25 is a side elevation cross-sectional view of an entry/exit ramp of the flume system illustrated in FIG. 13.

FIG. 26 is a flume system according to an embodiment of the invention.

FIG. 27 is a flume system according to an embodiment of the invention.

### DETAILED DESCRIPTION OF THE PREFERRED EMBODIMENTS

According to a preferred embodiment, a flume system embodied as a horse exercise pool is provided.

The illustrated exercise pool 10 includes an annular raceway 11 with an inner wall 12 and an outer wall 13 and adapted to hold a body of liquid, an entry and exit ramp 14 associated with the annular raceway 11, the entry and exit ramp 14 intersecting the annular raceway 11 at an acute angle.

The annular raceway 11 of the illustrated embodiment is located within a larger liquid holding tank. The tank is typically located at least partially below ground level.

According to the illustrated embodiment, the annular raceway 11 is circular.

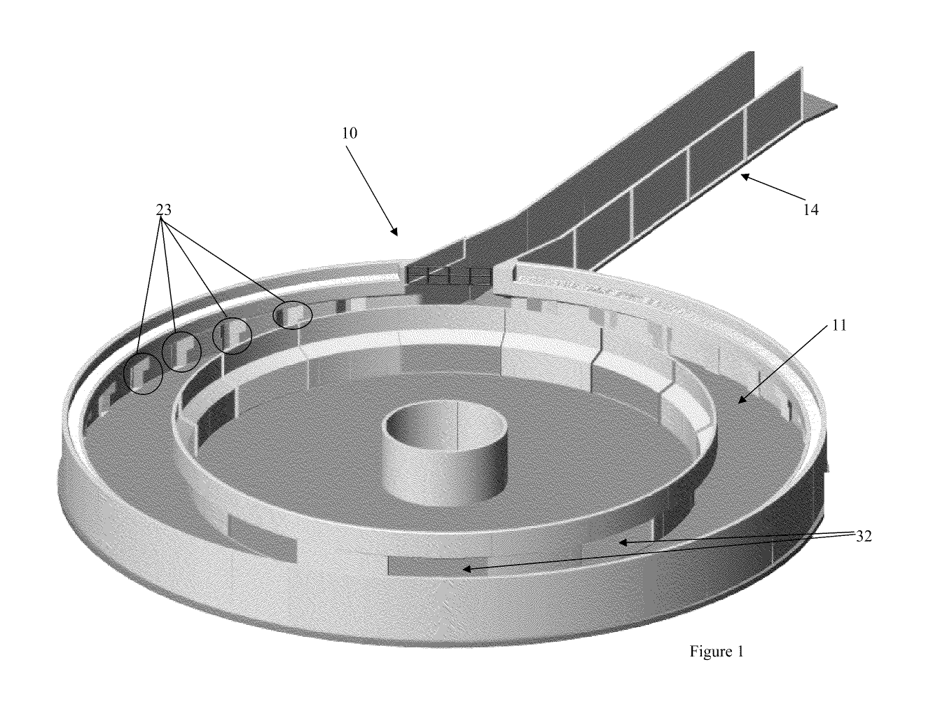

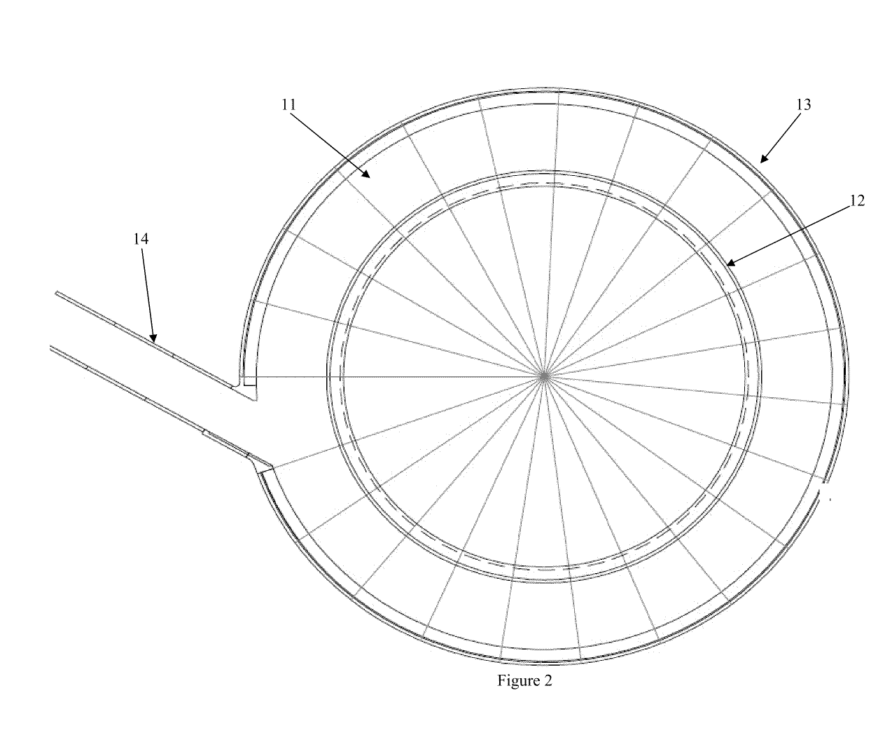

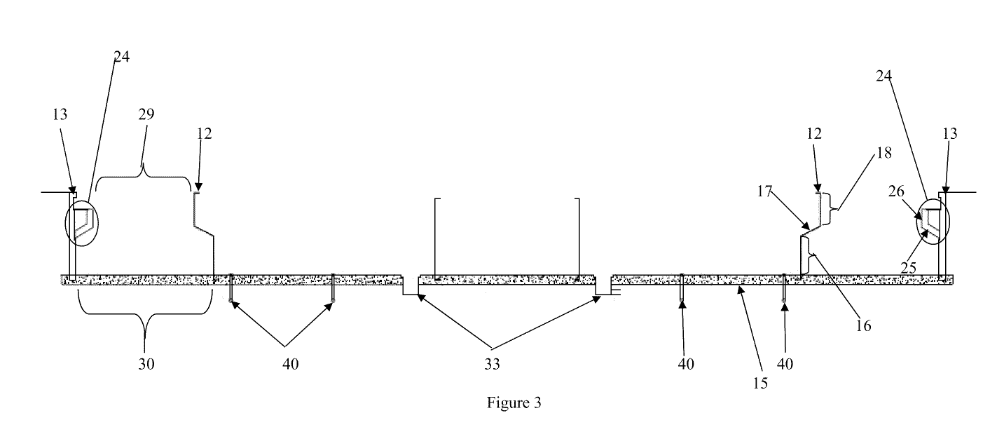

The inner 12 and outer 13 walls of the raceway 11 are arcuate and appropriately curved to form concentric circular walls as illustrated in FIG. 1. Each of the inner 12 and outer 13 walls are formed of a plurality of arcuate wall sections (best illustrated in FIG. 3) adapted to be attached to one another to form the walls. Further, the tank has a substantially planar floor 15.

The inner wall 12 is a wall with a substantially vertical lower portion 16 which extends approximately perpendicularly to the floor 15, an angled portion 17 extending upwardly and into the annular channel towards the outer wall 13, and a substantially vertical upper portion 18 which is located closer to the outer wall 13 than the lower portion 16.

Normally, the upper portion 18 of the inner wall 12 begins at a height above the floor 15 appropriate to locate the upper portion 18 adjacent (but spaced and appropriate distance from) the animal's body or torso (rather than the animal's legs) once the animal is located in the annular raceway 11.

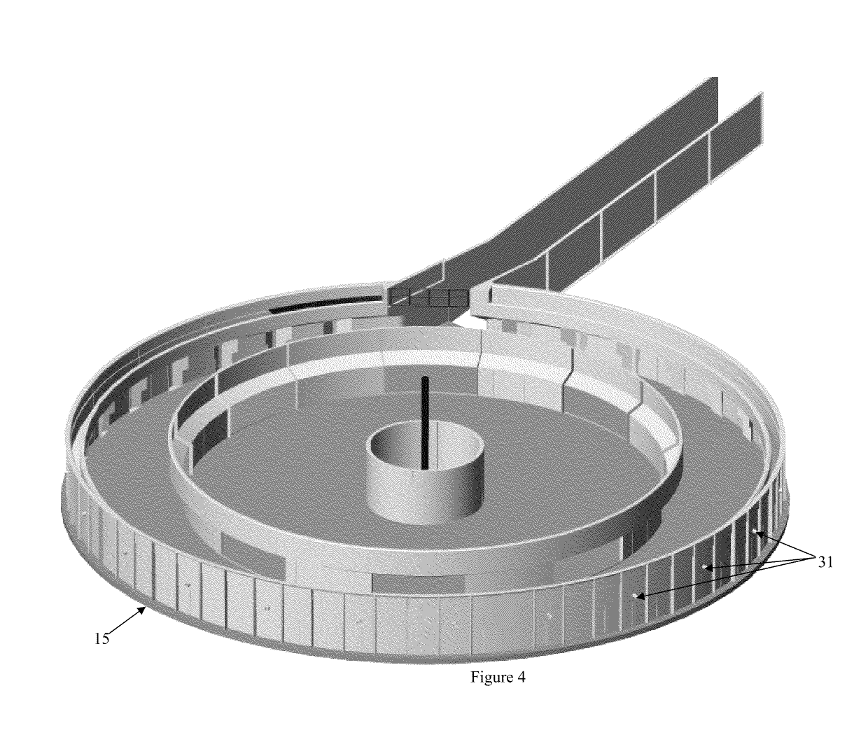

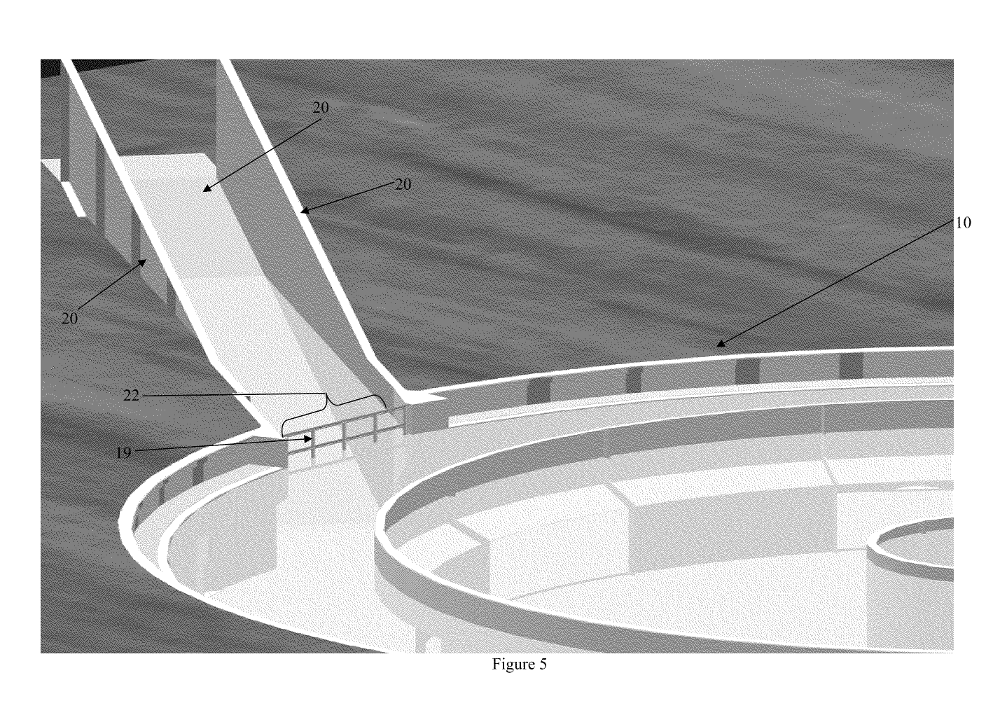

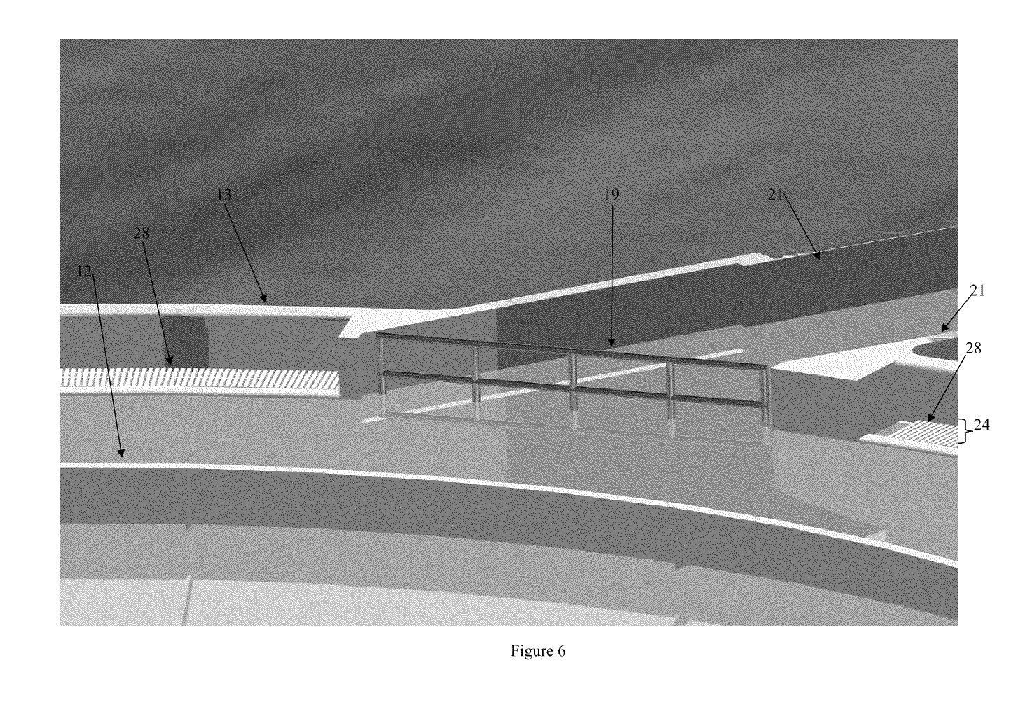

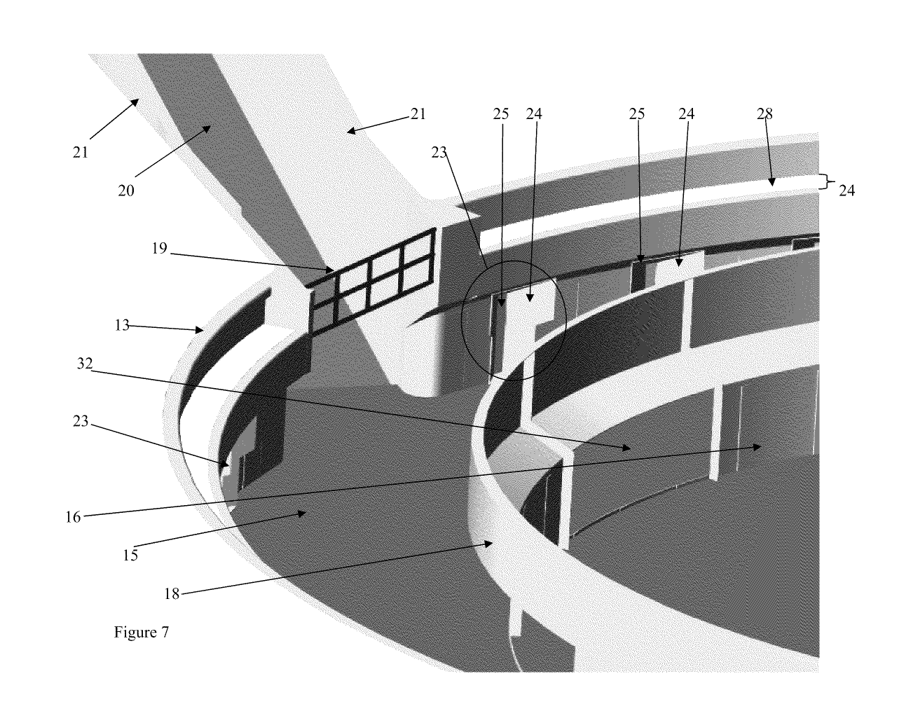

According to the illustrated embodiment, the outer wall 13 is a substantially planar sidewall which is substantially vertical and extends substantially perpendicularly to the floor 15 of the pool 10. As illustrated in FIGS. 5 to 7 in particular, the outer wall 13 is continuous except for a portion removed or absent to allow the entry and exit ramp 14 to communicate with the annular raceway 11.

There is a gate 19 provided to control or prevent entry of the animals from the entry and exit ramp 14 into the annular raceway 11. When closed, the gate 19 forms a part of the outer wall 13 so that animals circling in the annular raceway 11 cannot exit the raceway 11 unless the gate 19 is open. As illustrated, the gate 19 is provided only at an upper portion of the opening of the entry/exit ramp 14 with the remainder of the entry being clear.

The system of the present invention is also provided with an entry and exit ramp 14 associated with the annular raceway 11. Normally, the entry and exit ramp 14 extends downwardly to the raceway 11 with the floor 20 of the entry and exit ramp 14 being angled and smoothly intersecting with the floor 15 of the annular raceway 11.

The entry and exit ramp 14 is provided with a pair of substantially parallel sidewalls 21 that each meet with the outer wall 13 of the raceway 11 on opposite sides of an entry opening 22. The floor 20 of the entry and exit ramp 14 is provided with grip or grip means in order to minimise slippage of animals upon entry and exit from the pool 10.

Generally, the entry and exit ramp 14 intersects the annular raceway 11 at an acute angle. This allows entry of the animal through the entry ramp 14 in the direction of travel in the initial direction and allows the animal to more easily enter the exercise raceway 11. Once the animal has been turned into the opposite direction to that first traveled upon entry into the annular raceway 11, the animal can exit the exercise raceway 11 simply and easily as the animal is typically facing the entry and exit ramp 14 and are not required to execute a turn in order to access the entry and exit ramp 14. As illustrated, the entry and exit ramp 14 is normally provided approximately tangentially to the circular or oval exercise raceway 11.

The pool of the illustrated embodiment is further provided with a plurality of depression baffles 23 associated with the outer wall 13, each depression baffle 23 configured as a depression having angled surfaces extending away from the inner surface of the outer wall 13.

The depression baffles 23 are provided in the form of substantially V-shaped or Y-shaped depressions with a pair of angled surfaces 24, 25 meeting each other at an apex (not illustrated). The apex of the depression baffle 23 is located away from the inner surface of the outer wall 13.

The baffles 23 are provided in the lower portion 16 of the outer wall 13, extending from the floor 15 of the annular raceway 11 upwardly, with a constant cross sectional shape over their height.

The plurality of depression baffles 23 are spaced approximately equally about the outer wall, with the number of depression baffles 23 provided in a given pool will typically be determined according to the size of the system, namely the circumferential dimension of the outer wall 13.

The pool of the preferred embodiment also includes a waste removal system associated with the annular raceway 11. The waste removal system of the illustrated embodiment includes a pair of elements, namely a waste removal spillway 24 for the floating waste and a submerged waste removal portion for submerged waste.

The waste removal spillway 24 is located in an upper part of the exercise raceway 11 on the outer wall 13 and extends inwardly toward the inner wall 12, that is into the annular channel of the exercise raceway 11.

The shape of the waste removal spillway 24 mirrors the shape of the inner wall 12, that is, the spillway 24 includes an angled wall 25 extending upwardly and from the outer wall 13 toward the inner wall 12, and a substantially vertical upper portion 26 which define a channel 27 with the outer wall 13.

The waste removal spillway 24 is provided with a plurality of removable covers 28 located in an upper portion of the spillway 24. The covers 28 are adapted to allow waste to escape through the covers 28 but to prevent animals from placing body parts into the spillway 24.

As illustrated, the covers 28 have a plurality of slot openings configured in a grill formation. The covers are manufactured in sections, typically of approximately 1 m in length, in order to allow easy placement and removal in the spillway 24.

Generally, the upper portion 26 of the spillway 24 and the upper portion 18 of the inner wall 12 define an upper zone 29 in the annular raceway 11, and a lower zone 30 is defined between the outer wall 13 and the lower portion 16 of the inner wall 12 with the upper zone 29 being narrower than the lower zone 30 providing increased space in the lower zone 30 of the exercise raceway 11 for the animal's legs.

As alluded to above, the spillway 24 is adapted to collect floating waste which will typically overflow into the spillway 24 due to the turbulence created in the liquid due to the animals movement within the exercise raceway 11. The waste will then typically be collected and undergo separation processes in order to remove the waste from the water prior to reintroduction into the pool. There are removal outlets 31 located through the outer wall 13 and in communication with the spillway 24 to remove waste and water from the spillway 24.

The waste removal system of the illustrated embodiments also includes a submerged waste removal portion which is located in the lower zone 30 of the exercise raceway 11. Normally, the submerged waste removal portion includes a number of openings 32 located through the inner wall. Typically, the small amount of agitation in the liquid created by the animal's movement will tend to concentrate any submerged waste in the centre of the pool 10 or against a lower portion 16 of the inner wall 12. Provision of openings 32 in the inner wall 12 allows collection and removal of submerged waste.

In addition to the openings 32 in the inner wall 12, at least one radial depression 33 can be provided in the floor 15 of either the exercise raceway 11 or the pool 10 itself. The depressions 33 may assist with the collection of submerged waste and normally there will be one or more outlets located in communication with the depressions 33.

Directional liquid return pipes 40 are provided and oriented toward the radial depressions 33 at the centre of the pool 10, inside the inner wall 12 to assist with the collection and removal of submerged waste. The return pipes 40 are provided through the floor and extending upwardly. The return pipes 40 are radial and oriented to force liquid returning to the pool 10 to the centre of the pool.

The inner 12 and outer 13 walls will be modular and typically manufactured of a plastic material although other materials such as moulded fibreglass may be used. The inner 12 and outer 13 walls are usually integrally formed with all sidewalls and spillway walls. Typically, all of the surfaces provided will be smooth with any hard angles minimised and rounded edges on all corners used to minimise the chances that an animal could injure themselves whilst using the pool.

The angled entry/exit ramp 14, the depression baffles 23, the waste removal system with the spillway 24 and the waste removal system with the submerged waste removal system are all used in combination in the illustrated embodiment to provide a flume system of superior functionality.

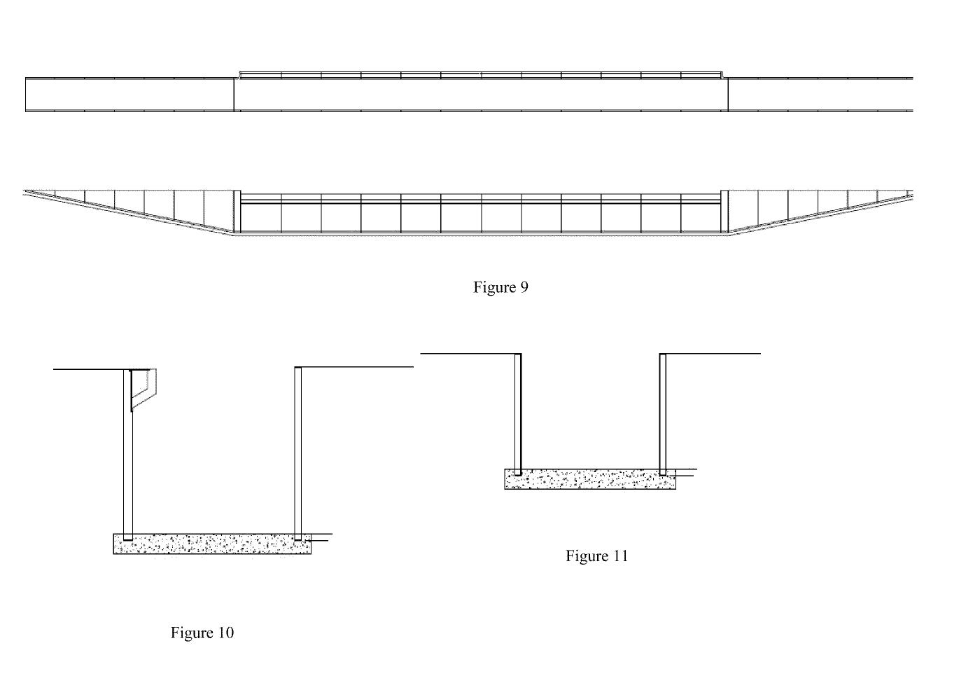

According to alternative embodiments, an oval pool (illustrated in FIG. 12) or an elongate pool (illustrated in FIGS. 9 to 11) may be provided. When provided in an oval configuration, the pool has a ramp leading downwardly to an oval raceway and a second ramp leading away from the raceway. The ramps are configured to be tangential to be oval raceway.

When provided in the elongate configuration, there will preferably be a ramp located at either end of an elongate track as illustrated in FIG. 9 in particular.

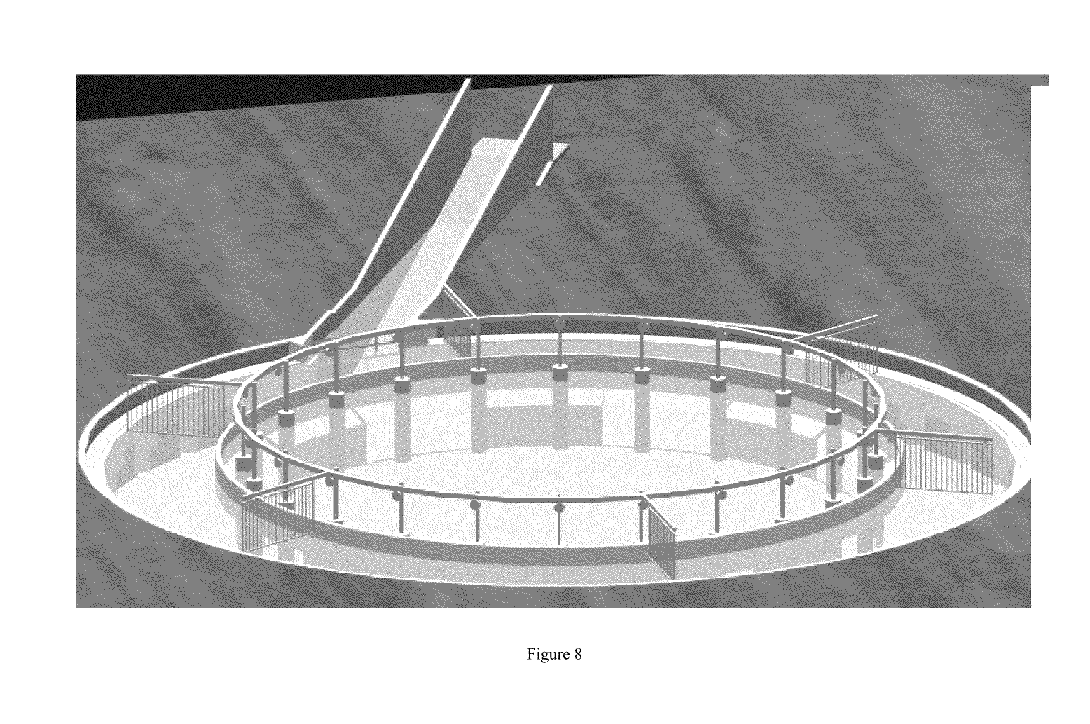

According to a further embodiment, a rotating animal separator or separation means may be provided, as illustrated in FIG. 8, so that more than one animal can exercise in the raceway at any one time with out impeding any other animal. Preferably, the animal separator will include a plurality of barriers or gates oriented across the raceway and mounted to be spaced about the raceway. Normally, the entire barrier assembly rotates around the raceway.

According to the illustrated embodiment, a plurality of supports are provided about the raceway but on the opposite side of the inner wall to the raceway itself. The supports extend upwardly above the level of the walls. Each of the supports will preferably include guide means.

A barrier support ring is provided, the ring supported by the plurality of support means. Each of the supports provided is provided with a ring support member, typically one adapted to support rotation of the ring relative to the raceway. Normally, the ring support member will be a substantially circular and bearing member adapted for rotation about a substantially horizontal axis. The ring support member is typically mounted on an outer surface of each support and spaced from the upper end of the support such that the ring can be mounted relative to the support and its position fixed but allowing rotation.

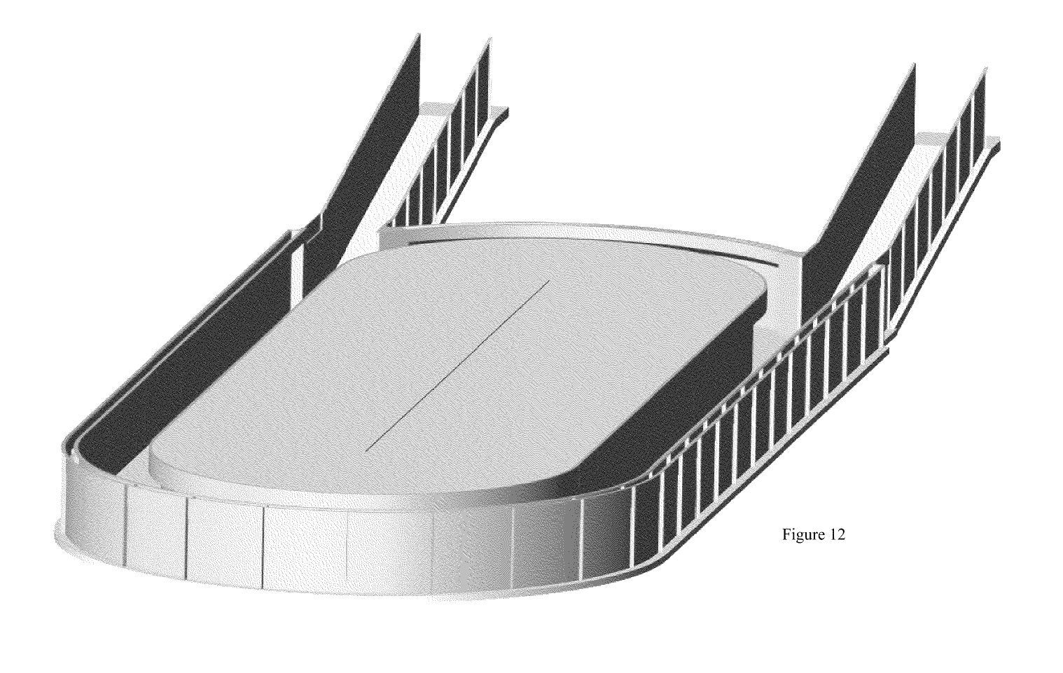

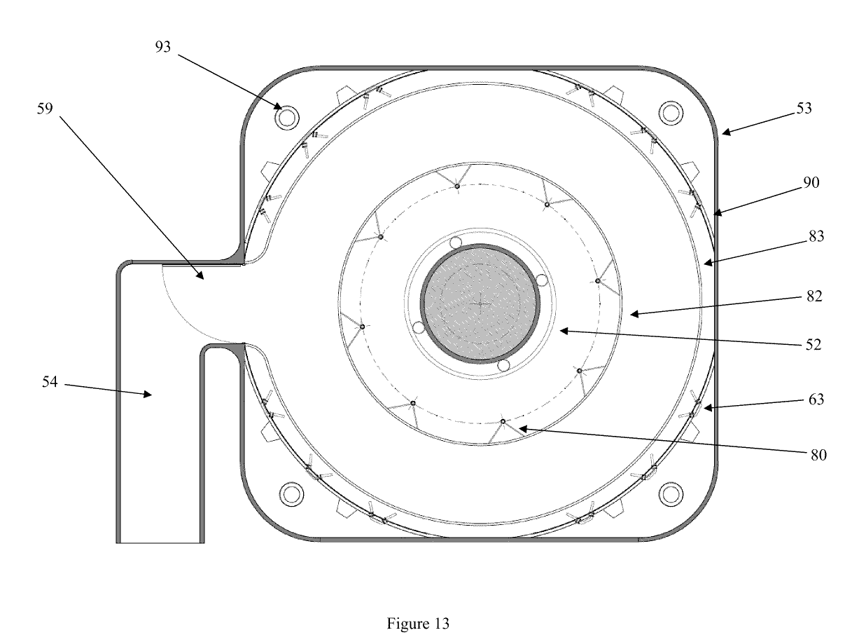

According to yet a further embodiment, as illustrated in FIGS. 13 and 14, the inner wall 52 is circular and the outer wall 53 is square with rounded corners. The entry/exit 54 extends perpendicularly from one of the sides of the outer wall 53, and has a gate 59 for permitting and restricting entry/exit. Between the inner wall 52 and the outer wall 53 is a pair of rails 82 and 83 which define the perimeter of the annular raceway. Namely, a circular inner rail 82 is provided around the inner wall 52, and a circular outer wall 83 is provided within the outer wall 53. The inner rail 82 and outer rail 83 are preferably spaced apart a fixed distance such that the annular raceway is of a consistent width. The inner rail 82 is held in place by supports 80, which are preferably made of stainless steel.

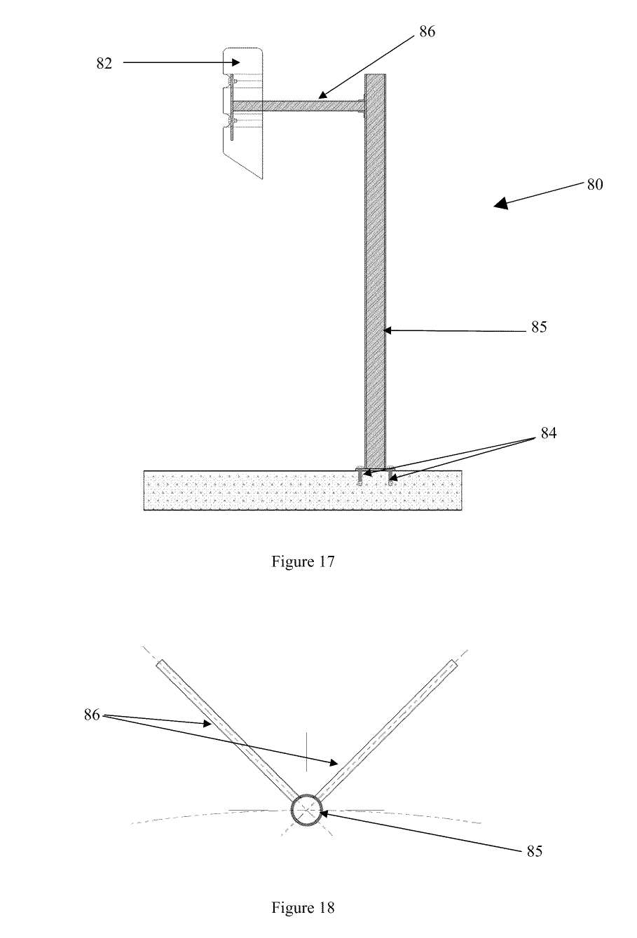

The supports 80, one of which is illustrated in more detail FIGS. 17 and 18, are affixed to the concrete floor of the pool by suitable affixing means 84 such as dynabolts or chembolts. The supports 80 have a substantially vertical member 85 that extends perpendicularly from the floor and then two horizontal members 86, preferably at a right angle, affixed to a rail 82 or 83. The two horizontal members 86 extend perpendicularly from the vertical member 85, and the rail 82 or 83 extends around the perimeter of the raceway. The support 80 may be used for either inner or outer rails, but in the illustrated embodiment just the inner rail 82 is held by the support 80 illustrated in FIGS. 17 and 18 as the outer rail 83 is affixed to a support adapted to extend from a mid wall 90 between the inner wall 52 and outer wall 53.

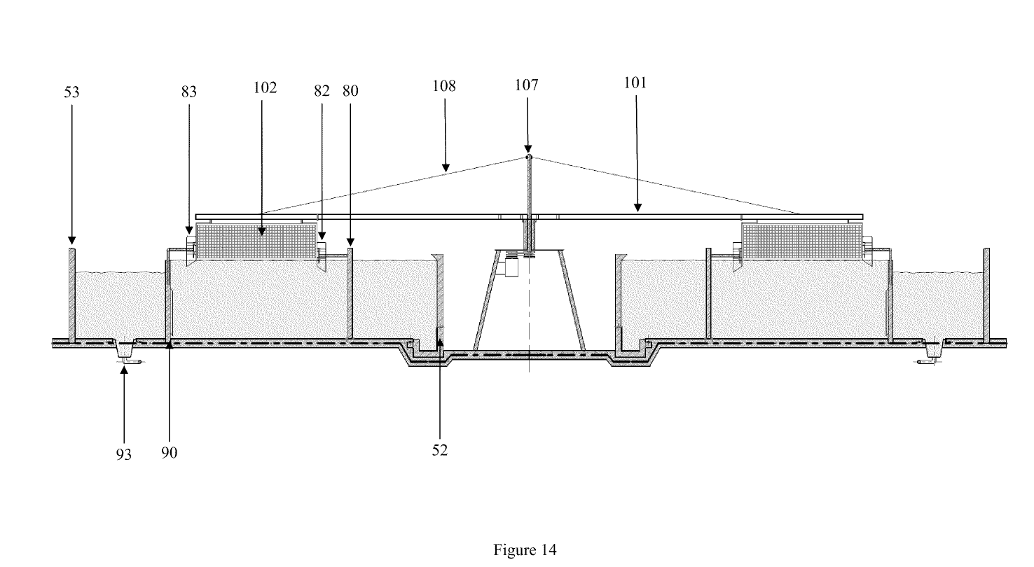

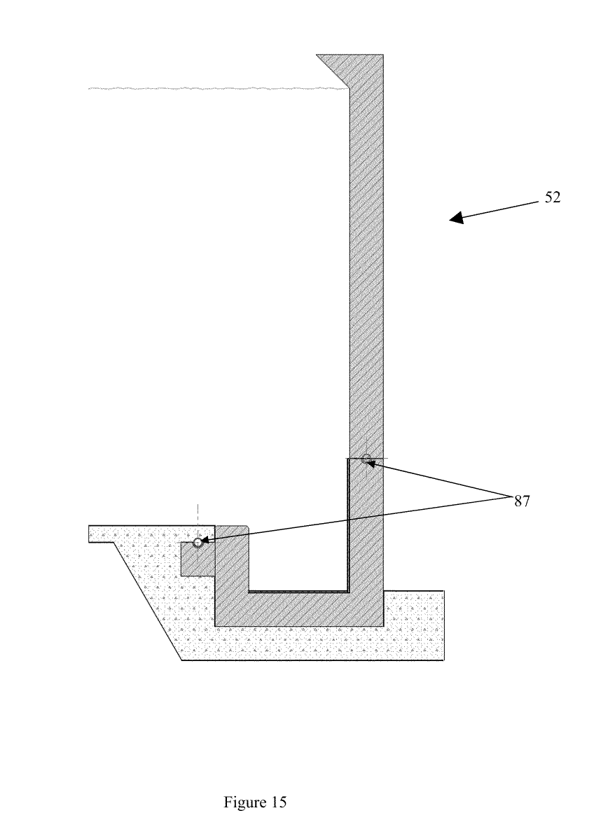

The inner wall 52, illustrated in more detail in FIG. 15, is made of fibreglass and has a channel adjacent the floor. Preferably the vertical portion of the inner wall 82 is a 100 mm thick fibreglass panel. The inner wall preferably has a waterstop material 87 to provide additional sealing between joints in the inner wall 82.

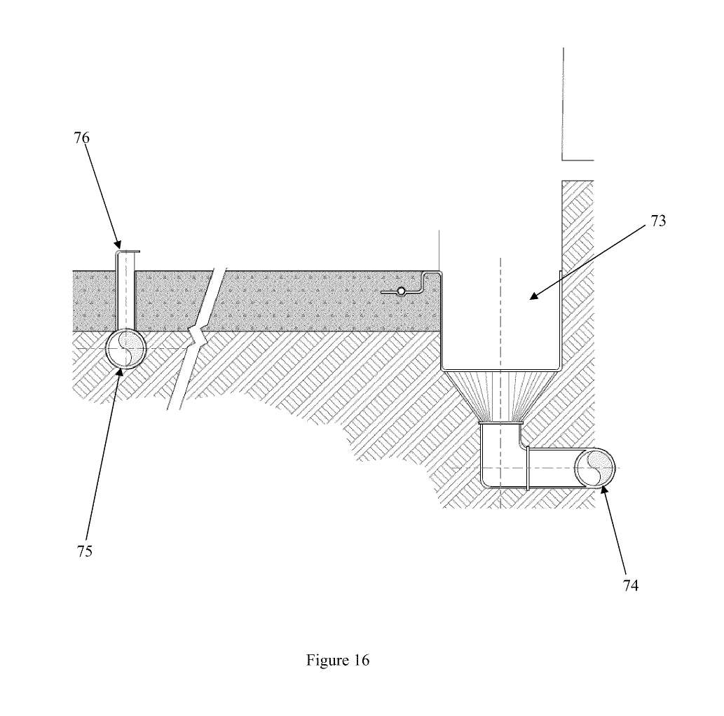

In this embodiment of the flume system, a depression in the form of a drain 73 is provided, as illustrated in FIG. 16. The drain 73 is preferably located between the inner wall 52 and inner rail 82 to facilitate collection of waste therebetween. The drain 73 has an outlet 74 and an inlet 75. The inlet 75 has a fluid director or directing means 76 to direct fluid (i.e. water) towards the drain 73. This creates a current between the inlet 75 and outlet 74 which carries waste into the drain 73. Preferably there is a filter or filtering means (not shown) between the outlet 74 and inlet 75 that removes the waste and treats the water.

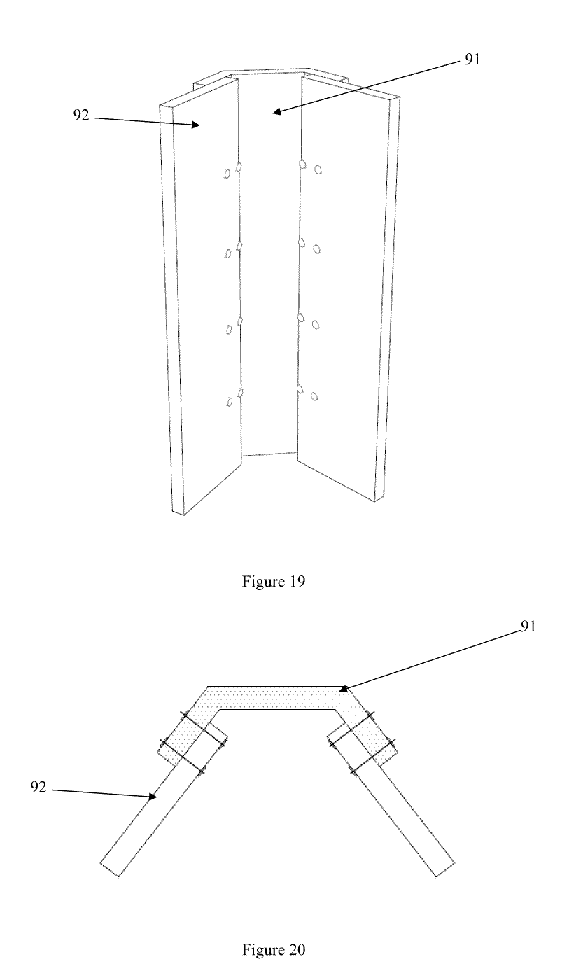

The baffles 63, as illustrated in FIGS. 19 and 20, have a support member 91 made of fibreglass with rubber panels 92 extending therefrom. The support member 91 is shaped to angle the rubber panels 92 outward in a generally ‘V’ shape. The baffles 63 are spaced apart and affixed to the mid wall 90. The rubber panels 92 do not extend past the innermost perimeter of the outer rail 83, avoiding contact with a user/animal in the flume system. Because the panels 92 are made of a resilient rubber, even if an animal, such as a horse, were to knock its legs, or any other part of its body, they should not be injured.

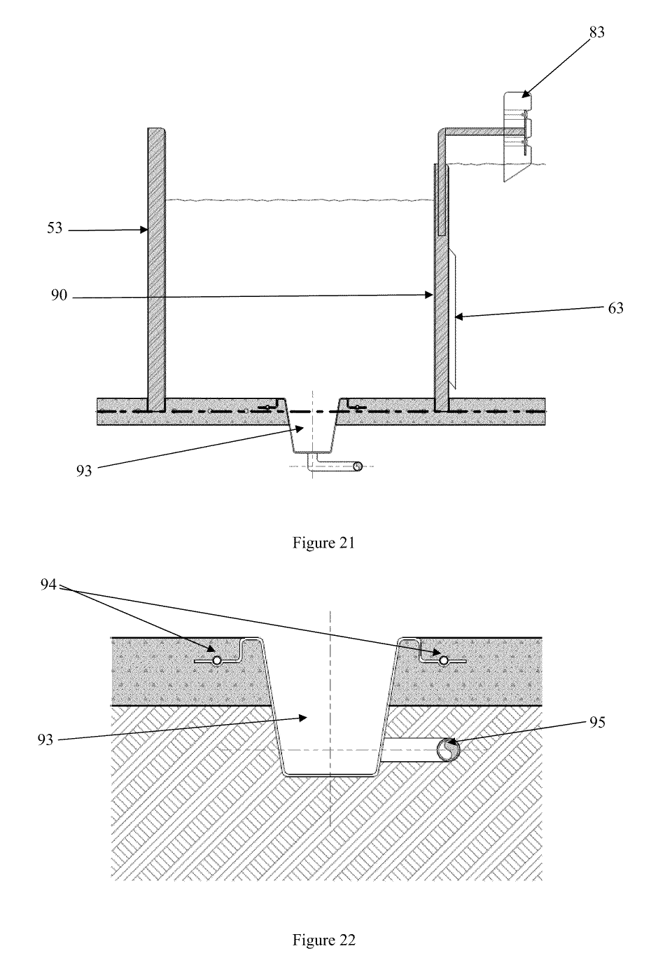

FIG. 21 illustrates a section of the flume system between the outer wall 53 and outer rail 83 (inclusive). This cross section is across one of the corners of the flume system illustrated in FIG. 13. Between the outer wall 53 and mid wall 90 (with outer rail 83 thereon) is a drain sump 93. The drain sump 93 has a fibre glass lining and a water stop seal 94 between the lining and the concrete floor. The drain sump 93 also has a drain outlet 95, which in the preferred embodiment is 50 mm, to facilitate the removal of waste water and any waste contained therein. In this embodiment, there are a total of four drainage sumps 92, provided in the corners between the circular mid wall 90 and the generally square outer wall 53.

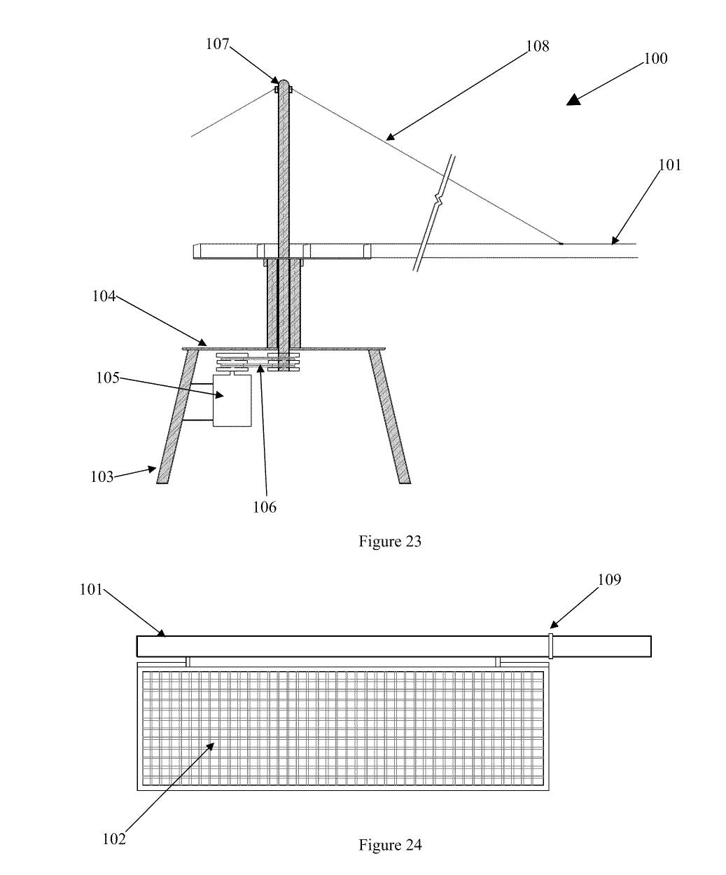

A rotating mechanism 100 is provided in the middle of the raceway. The rotating mechanism has arms 101 extending radially therefrom with dividing panels 102 thereon. FIG. 23 illustrates a close up of the rotating mechanism 100 and FIG. 24 illustrates a close up of a dividing panel 102. The rotating mechanism 100 has legs 103 and a plate 104. Located beneath the plate is an electrical motor 105 with a pulley system 106 (or gear system) connecting the rotor of the electrical motor 105 to an axle 107. The arms 101 are attached to the axle 107, and their weight supported by a guide wire 108 that extends from the top of the axle 107.

As the electrical motor 105 rotates, pulley system 106 causes the axle to rotate, which in turn causes the arms 101 with dividing panels 102 thereon, to rotate. Users/animals within the flume system are preferably segregated by the dividing panel(s) 102 and walk and/or swim at a similar rate to the rotation of the dividing panel(s) 102.

The arms 101 have a hinge109 adjacent the dividing panel 102. The hinge 109 allows the outer portion of the arm 101 that is adjacent the dividing panel 102 to rotate relative to the rest of the arm 101. This is primarily for safety reasons, and ensures that any user/animal using the flume system is not forceably moved by the panel 102. The dividing panel 102 is made of a mesh that reduces resistance to fluids such as air and water. Preferably the dividing panels 102 are located just above the water level in the flume system, and therefore are only moved through air. However, the dividing panels 102 may be at least partially submerged, or may come in to contact with water when the water is agitated.

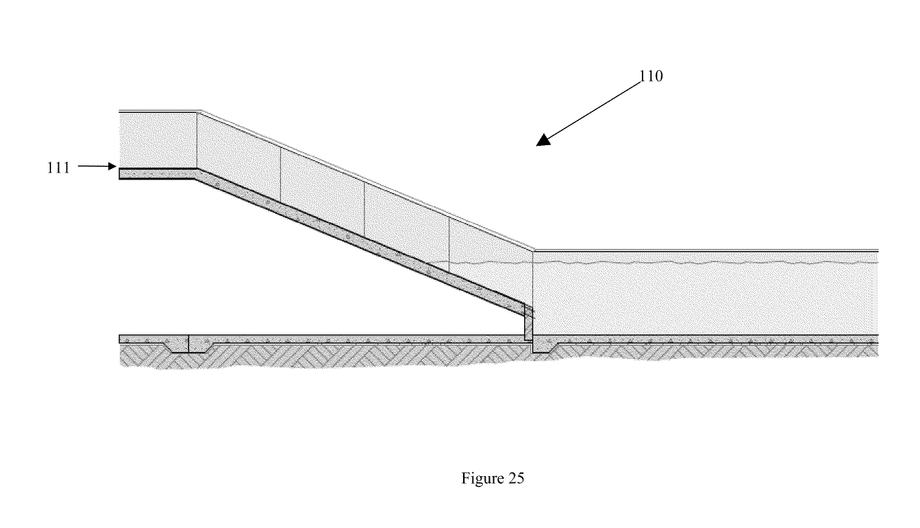

An entry/exit ramp 110 is illustrated in FIG. 25. The ramp starts at a higher level 111 out of the water and is angled downward to the concrete floor of the flume system. As illustrated in FIG. 13, a gate 59 is provided that selectively opens/closes the entry/exit ramp 110 from the rest of the flume system.

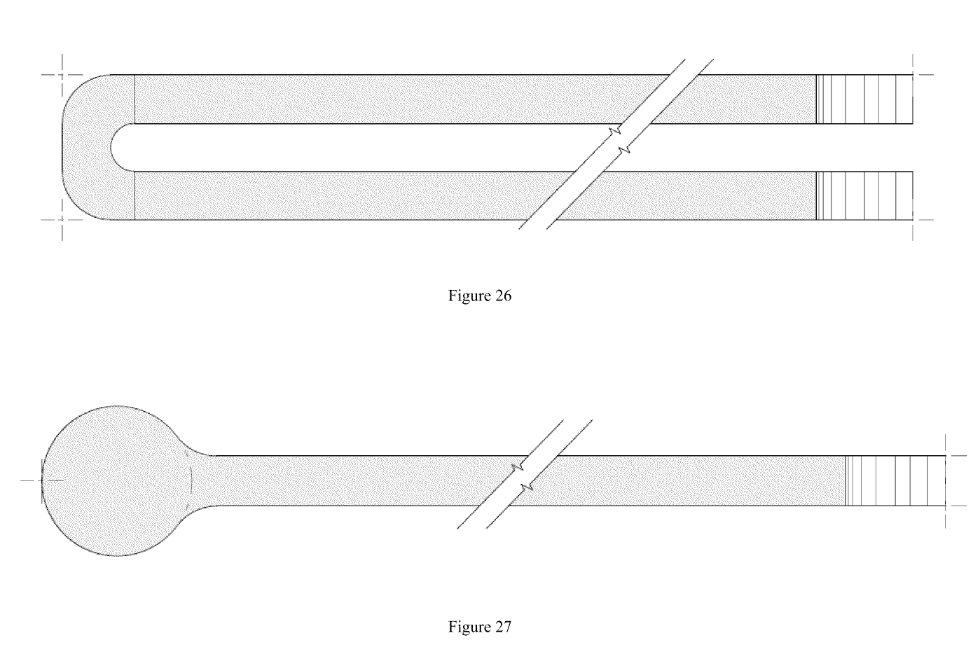

Flume systems according to different embodiments of the invention are illustrated in FIGS. 26 and 27. Instead of an annular raceway, the raceway is elongate and provides a channel for the user/animal to traverse. Although not illustrated in detail, these embodiments may include baffles and/or waste removal systems as hereinbefore described.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

1. A flume system including an annular raceway with at least one inner and at least one outer wall and adapted to hold a body of liquid, an entry and exit means associated with the annular raceway, wherein the entry and exit means intersects the annular raceway at an acute angle.

2. A flume system including a raceway with at least one inner and at least one outer wall and adapted to hold a body of liquid, an entry and exit means associated with the annular raceway, and a plurality of baffles provided in at least one of either the inner or outer walls, each baffle configured as a depression having at least a pair of angled surfaces extending away from the inner surface of the wall in which the baffle is located.

3. A flume system including a raceway with at least one inner and at least one outer wall and adapted to hold a body of liquid, an entry and exit means associated with the annular raceway, and a waste removal system associated with the annular raceway including at least an annular overflow drain provided on either the inner or outer wall to remove floating waste, the overflow drain defined between a wall extending into the annular raceway and the inner or outer wall of the raceway.

4. A flume system including a raceway with at least one inner and at least one outer wall and adapted to hold a body of liquid, an entry and exit means associated with the annular raceway, and a waste removal system associated with the annular raceway including at least one opening in a lower portion of at least one of either the inner or outer wall of the raceway associated with a suction and filtration means to remove submerged waste.

5. A flume system as claimed in any one of the preceding claims wherein the raceway is at least partially annular.

6. A flume system as claimed in any one of the preceding claims wherein the raceway is at least partially contained within a tank located at least partially below ground level.

7. A flume system as claimed in any one of the preceding claims wherein the at least one inner and at least one outer wall of the raceway are arcuate and appropriately curved to form concentric walls.

8. A flume system as claimed in any one of the preceding claims wherein each of the at least one inner and at least one outer walls are formed from a plurality of modular wall sections adapted to be attached to one another to form the walls.

9. A flume system as claimed in any one of the preceding claims wherein the at least one inner wall is provided with a substantially vertical lower portion which extends approximately perpendicularly to the floor of the raceway, an angled portion extending upwardly and into the raceway towards the at least one outer wall, and a substantially vertical upper portion which is located closer to the at least one outer wall than the lower portion.

10. A flume system as claimed in claim 9 wherein the upper portion of the at least one inner wall begins at a height above the floor appropriate to locate the upper portion adjacent a user's torso once the user is located in the raceway.

11. A flume system as claimed in any one of the preceding claims wherein a closure means is provided to control or prevent entry of users from the entry and exit means into the raceway and which, when closed, forms a part of the outer wall so users in the raceway cannot exit the raceway unless the closure means is open.

12. A flume system as claimed in claim 5 wherein a turnaround zone is provided to allow a user to turn into the opposite direction to that first traveled upon entry into the annular raceway.

13. A flume system as claimed in claim 5 wherein the entry ramp and exit ramp is provided approximately tangentially to the annular raceway.

14. A flume system as claimed in any one of the preceding claims wherein the raceway is provided with a plurality of baffles associated with at least one of either the at least one inner or at least one outer wall, each baffle configured as a depression having at least one angled surface extending away from an inner surface of the wall in which the baffle is located.

15. A flume system as claimed in claim 14 wherein the baffles are provided in the form of substantially V-shaped or Y-shaped depressions with a pair of angled surfaces meeting each other at an apex with the apex of the depression located away from the inner surface of the wall in which the baffles are provided.

16. A flume system as claimed in any one of the preceding claims further including a waste removal system including at least one of a waste removal spillway for the floating waste and a submerged waste removal portion for submerged waste.

17. A flume system as claimed in claim 16 wherein the waste removal spillway is located in an upper part of the raceway on the outer wall extending inwardly toward the inner wall.

18. A flume system as claimed in claim 6 wherein the small amount of agitation in the liquid created by the user's movement concentrates any submerged waste towards the at least one inner wall and openings are provided in the at least one inner wall allowing collection and removal of submerged waste from the raceway.

19. A flume system as claimed in claim 18 further including one or more depressions provided in the floor of the tanks inside the at least one inner wall to assist with the collection of submerged waste.

20. A flume system according to any one of claims 16 to 19 wherein the waste collected undergoes separation processes in order to remove the waste from the liquid prior to reintroduction into the raceway.

21. A flume system as claimed in any one of the preceding claims further including a rotating animal separation means so that more than one animal can exercise in the raceway at any one time with out impeding any other animal.

22. A flume system as claimed in any one of the preceding claims for use as an animal exercise pool.
